(19) United States
(12) Patent Application Publication
(10) Pub. No.: US 2011/0241884 A1
(43) Pub. Date: Oct. 6, 2011

(54) Asset protection keychain

(76) Inventor: Calvin Lewis Edwaeds, Newark, NJ (US)

(21) Appl. No.: 12/798,378

(22) Filed: Apr. 5, 2010

(51) Int. Cl. G08B 23/00

(52) U.S. Cl. 340/573.1

(57) ABSTRACT

This is an invention that seeks to help preserve consumers largest assets in a unique but wholly relevant manner. For most consumers their houses and cars are their most expensive and largest assets, (but the invention holds it's relevance with all assets that use keys), as it so happens both of these assets have a very important connection to keys. At the point that a person reaches for his keys this is also the point where he leaves or enters his most important asset this is the time where great danger can happen to his assets. Some common dangers as it relates to homes are fire hazards; windows open; doors open, water left running as it relates to cars; some important safety and protection checks may include; daily tire check, oil checks brake fluid checks this invention fits on the end of an item that connects the items keys to the invention. And holds them together to be used at the same time. It allows the user to take note of the particular time in question, then he can use the information on the invention to become aware; at the most important and relevant time; that he needs to make important asset protection checks. At that relevant; time he can use the information provided by the invention to check off that he has performed the asset protection checks that he may be most concerned about.

### BACKGROUND OF THE INVENTION

1. Field of the Invention

The invention relates to an asset protection device and more particularly an asset protection device in the form of a keychain with a means to remind the user that he has made relevant safety and asset protection steps related to the asst he is using the keys for.

2. Description of the Prior Art

There are many multifunctional key chains available, such as keychain bottle openers and even keychain alarms and whistles. These keychain add-ons perform functions separate from the main function of keys, which is asset protection, the “Asset Protection Key” chain in contrast supports the main function of keys, and it is an add-on that's meant to be used at the same time and place as the keys.

### BRIEF SUMMARY OF THE INVENTION

The invention is a key chain that acts as an asset protection device. The invention protects assets that also use keys as an important asset protection device also. The invention makes the user aware that he has made relevant safety and asset protection checks. A means is provided to connect the invention to the assets keys.

It is an object of the invention to provide another means of asset protection to cooperate with the assets keys which may be the primary means of asset protection

Another object of the invention is to make asset protection more efficient. The invention makes asset protection more efficient because the user can ease worries concerning the safety and protection of the asset and he can physically lock the asset all at the same time and place

### DESCRIPTION OF THE DRAWINGS

FIG. 1 is a frontal view of the Asset Protection Keychain

### DESCRIPTION OF THE DRAWING

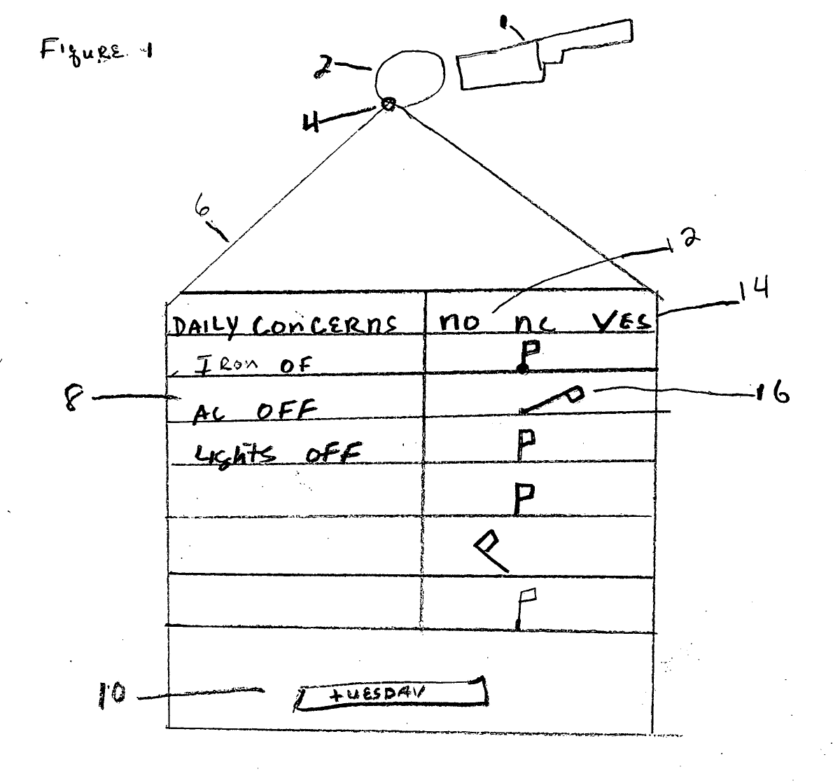

Referring to FIG. 1 an embodiment of the asset protection keychain is shown. In this general embodiment we see a ring 2 which is used to hold a key 1 means are provided to attach the ring holding the key 4 to the key chain 6 the special features of the keychain 6 are what makes the keychain unique and able to fulfill its purpose of asset protection. The key chain contains important areas of concern relating to safety and asset protection for when a person leaves the house or relevant asset 8. The invention also includes a means to identify the relevant date/time period 10. In order to be effective the invention must allow the user to become aware that he has made important safety and protection checks related to the asset under consideration. So the invention has a position where it says no the asset protection check has not been made 12 and it also has a position where the user can determine and; be reminded that yes the asset protection check has been made 14. The invention also includes a selector switch 16 that the user will manipulate to fulfill the function of the invention.

Since it is obvious that changes can be made to the invention in terms of construction, designs and the areas of interest included as reminders; and that different embodiments of the invention may be made without leaving the scope of the invention. It is intended that all matters contained in the above description or shown in the accompanying drawings shall be interpreted as illustrative and not in a limiting sense.

1. I claim as my invention a device to protect personal assets by working in cooperation with the asset's keys:
Comprising
1(a) A keychain with a means display to relevant asset protection issues that the consumer would like to address prior to leaving the house and be reminded that he has addressed throughout the day.
(b) A means to hold the asset's keys.
(©) A means to hold the asset's keys and the relevant asset protection issues together.
(d) A means to show that; yes the asset protection issue has been addressed; and no the asset protection issue has not been addressed.
(e) A means to differentiate from yes and from no.
(f) A means to identify and adjust the date and time periods to match the date and time for which issues needs to be addressed.
